(19) United States
(12) Patent Application Publication
(10) Pub. No.: US 2008/0219531 A1
(43) Pub. Date: Sep. 11, 2008

(54) Method and Apparatus For Metching First and Second Image Data of an Object

(75) Inventor: Roel Truyen, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/997,418

(22) PCT Filed: Jul. 20, 2006
(86) PCT No.: PCT/IB2006/052489

§ 371 Date: Jan. 31, 2008

(30) Foreign Application Priority Data
Aug. 1, 2005 (EP) 05107089.4

(51) Int. Cl. G06K 9/00

(52) U.S. Cl. 382/130

(57) ABSTRACT

A method of matching prone and supine colon image data is disclosed. The method comprises matching prone centerline colon data with supine centerline colon data to identify partially matching sections of the prone and supine centerlines, and identifying a portion of the prone centerline (Trans(PO)) corresponding to a gap in the supine centerline data. The portion (Trans(PO)) of the prone centerline data corresponding to a gap in the supine centerline data is then fit between the end points (TP(S1), TP(SO)) of the gap in the supine centerline data to provide a continuous section of centerline data to enable data in the prone colon image to be automatically matched to data in the supine colon image.

The present invention relates to a method and apparatus for matching first and second image data of a tubular object, and relates particularly, but not exclusively, to a method and apparatus for matching first and second scan data of a colon.

CT colonography (virtual colonoscopy) is an increasingly important technique used to detect polyps in the colon. In order to inspect images of the inner wall of the colon, a centerline of the colon is determined by means of wavefront propagation and morphological thinning techniques, which will be familiar to persons skilled in the art. The tracked centerline is then used as a navigation guide to inspect an image of the inner wall of the colon.

In order to obtain complete image data for the inner wall of the colon, it is usual to perform two scans of the same patient, one in a prone position and one in a supine position. In particular, this is in order to overcome the problems of partial collapse of the bowel due to insufficient insufflation, pressure of abdominal organs, or bowel spasm (since it is not possible to detect polyps in the collapsed area, and a second scan in a different position will usually not have collapses in the same areas), and to overcome obscuring of parts of the image caused by residual fluid due to incomplete cleansing of the patent, since a polyp hidden below the fluid cannot be seen, while the fluid will change position between the two positions of the patent.

In order to distinguish a detected polyp from residual matter, it is generally necessary to find the suspected polyp in both scans and determine whether it has changed position in the second scan. However, locating in a second scan the position of a suspected polyp detected in a first scan is generally a time consuming task. Techniques exist to automatically warp the tracked centerlines from the prone and supine scans, but these techniques require complete centerlines.

However, when a collapse in the colon is present, automated centerline tracking is not straightforward and generally results in a number of separate centerline segments. Techniques have been proposed to overcome this problem by tracking through collapsed regions using image greyvalue properties, but have the drawback that the image data contains insufficient information, and it is difficult to distinguish the colon wall from its surroundings. Techniques have also been proposed which involve connecting separate air segments, but these suffer from the drawback of using a model of the colon which is too simple, and it therefore becomes difficult to locate anatomical landmarks. As a result, automated prone-supine matching becomes difficult.

Preferred embodiments of the present invention seek to overcome the above disadvantages of the prior art.

According to an aspect of the present invention, there is provided an apparatus for matching first image data, representing a first image of a tubular object, with second image data, representing a second image of said object, the apparatus comprising at least one processor, for receiving first data, obtained from first image data representing a first image of a tubular object, wherein said first data represents a plurality of locations adjacent a longitudinal centerline of said first image, for receiving second data, obtained from second image data representing a second image of said object, wherein said second data represents a plurality of locations adjacent a longitudinal centerline of said second image, and for matching said first data with said second data, to provide third data representing a plurality of locations, each of which corresponds to at least some of said first data and at least some of said second data, determining fourth data, representing a plurality of said locations corresponding to at least some of said first data but not corresponding to at least some of said second data, and combining said third and fourth data to provide fifth data representing a plurality of consecutive said locations corresponding to at least some of said third data and at least some of said fourth data.

This provides the advantage of providing data representing a continuous portion of the centerline of the object which, for example in the case of colon imaging, enables matching of colon wall image data in prone and supine scans of the colon to be carried out automatically.

At least one said processor may be adapted to match said first data with said second data by applying a mapping process to said first and second data wherein a respective cost value is allocated to a plurality of corresponding pairs of said first and second data, and said cost value represents similarity of a line joining a said location represented by said first data to adjacent said locations represented by said first data to a line joining a said location represented by said second data to adjacent said locations represented by said second data.

This provides the advantage of enabling the best match between the first and second sets of data to be carried out automatically.

The cost value may represent similarity of direction of a line passing through consecutive locations represented by said first data to direction of a line passing through consecutive locations represented by said second data.

The cost value may represent similarity of curvature of a line passing through consecutive locations represented by said first data to curvature of a line passing through consecutive locations represented by said second data.

At least one said processor may be adapted to apply said mapping process to at least part of said first data, representing a plurality of consecutive said locations, and to at least part of said second data, to allocate a respective cost value to a plurality of combinations of pairs of said first and second data, to determine a respective sum of cost values for the pairs of data of each said combination, and to select said third data on the basis of said sums of cost values.

At least one said processor may be adapted to exclude from said sum of cost values data corresponding to locations adjacent one or more ends of said plurality of consecutive locations and having cost values above a selected first value.

At least one said processor may be adapted to provide said third data by selecting data having the lowest said sum of cost values.

At least one said processor may be adapted to allocate a correlation value to at least some of said third data, wherein said correlation value represents congruence of locations represented by said first data with locations represented by said second data.

The correlation value may be dependent upon the sum of products of coordinate values of locations represented by said first data with respective coordinate values of said locations represented by said second data.

The correlation value may be dependent upon the sum of products of deviations of coordinate values of locations represented by said first data with respective coordinate values of said locations represented by said second data.

This provides the advantage of compensating for movement of a patient between scans providing first and second image data from which said first and said second data are obtained.

At least one said processor may be adapted to reject third data having a correlation value below a selected second value.

This provides the advantage of enabling the best match between the first and second data to be automatically selected.

At least one said processor may be adapted to obtain said first and second data from first and second image data of said object.

According to another aspect of the present invention, there is provided an apparatus for displaying first and second images of a tubular object, the apparatus comprising an apparatus as defined above and at least one display device.

The apparatus may further comprise at least one imaging apparatus for providing said first and second image data.

According to a further aspect of the present invention, there is provided a method of matching first image data, representing a first image of a tubular object, with second image data, representing a second image of said object, the method comprising:

matching first data, obtained from first image data representing a first image of a tubular object, with second data, obtained from second image data representing a second image of said object, wherein said first data represents a plurality of locations adjacent a longitudinal centerline of said first image and said second data represents a plurality of locations adjacent a longitudinal centerline of said second image, to provide third data representing a plurality of locations, each of which corresponds to at least some of said first data and at least some of said second data;

determining fourth data, representing a plurality of said locations corresponding to at least some of said first data but not corresponding to at least some of said second data; and

combining said third and fourth data to provide fifth data representing a plurality of consecutive said locations corresponding to at least some of said third data and at least some of said fourth data.

This provides the advantage of providing data representing a continuous portion of the centerline of the object which, for example in the case of colon imaging, enables matching of colon wall image data in prone and supine scans of the colon to be carried out automatically.

Matching said first data with said second data may comprise applying a mapping process to said first and second data wherein a respective cost value is allocated to a plurality of corresponding pairs of said first and second data, and said cost value represents similarity of a line joining a said location represented by said first data to adjacent said locations represented by said first data to a line joining a said location represented by said second data to adjacent said locations represented by said second data.

This provides the advantage of enabling the best match between the first and second sets of data to be carried out automatically.

The cost value may represent similarity of direction of a line passing through consecutive locations represented by said first data to direction of a line passing through consecutive locations represented by said second data.

The cost value may represent similarity of curvature of a line passing through consecutive locations represented by said first data to curvature of a line passing through consecutive locations represented by said second data.

The method may further comprise applying said mapping process to at least part of said first data, representing a plurality of consecutive said locations, and to at least part of said second data, allocating a respective cost value to a plurality of combinations of pairs of said first and second data, determining a respective sum of cost values for the pairs of data of each said combination, and selecting said third data on the basis of said sums of cost values.

The method may further comprise excluding from said sum of cost values data corresponding to locations adjacent one or more ends of said plurality of consecutive locations and having cost values above a selected first value.

Providing said third data may comprise selecting data having the lowest said sum of cost values.

The method may further comprise the step of allocating a correlation value to at least some of said third data, wherein said correlation value represents congruence of locations represented by said first data with locations represented by said second data.

The correlation value may be dependent upon the sum of products of coordinate values of locations represented by said first data with respective coordinate values of said locations represented by said second data.

The correlation value may be dependent upon the sum of products of deviations of coordinate values of locations represented by said first data with respective coordinate values of said locations represented by said second data.

This provides the advantage of compensating for movement of a patient between scans providing first and second image data from which said first and said second data are obtained.

The method may further comprise rejecting third data having a correlation value below a selected second value.

This provides the advantage of enabling the best match between the first and second data to be automatically selected.

The method may further comprise the step of obtaining said first and second data from first and second image data of said object.

According to a further aspect of the present invention, there is provided a data structure for use by a computer system for matching first image data, representing a first image of a tubular object, with second image data, representing a second image of said object, the data structure including:

first computer code executable to match first data, obtained from first image data representing a first image of a tubular object, with second data, obtained from second image data representing a second image of said object, wherein said first data represents a plurality of locations adjacent a longitudinal centerline of said first image and said second data represents a plurality of locations adjacent a longitudinal centerline of said second image, to provide third data representing a plurality of locations, each of which corresponds to at least some of said first data and at least some of said second data;

second computer code executable to determine fourth data, representing a plurality of said locations corresponding to at least some of said first data but not corresponding to at least some of said second data; and

third computer code executable to combine said third and fourth data to provide fifth data representing a plurality of consecutive said locations corresponding to at least some of said third data and at least some of said fourth data.

The first computer code may be executable to match said first data with said second data by applying a mapping process to said first and second data wherein a respective cost value is allocated to a plurality of corresponding pairs of said first and second data, and

said cost value represents similarity of a line joining a said location represented by said first data to adjacent said locations represented by said first data to a line joining a said location represented by said second data to adjacent said locations represented by said second data.

The cost value may represent similarity of direction of a line passing through consecutive locations represented by said first data to direction of a line passing through consecutive locations represented by said second data.

The cost value may represent similarity of curvature of a line passing through consecutive locations represented by said first data to curvature of a line passing through consecutive locations represented by said second data.

The first computer code may be executable to apply said mapping process to at least part of said first data, representing a plurality of consecutive said locations, and to at least part of said second data, to allocate a respective cost value to a plurality of combinations of pairs of said first and second data, to determine a respective sum of cost values for the pairs of data of each said combination, and to select said third data on the basis of said sums of cost values.

The first computer code may be executable to exclude from said sum of cost values data corresponding to locations adjacent one or more ends of said plurality of consecutive locations and having cost values above a selected first value.

The first computer code may be executable to provide said third data by selecting data having the lowest said sum of cost values.

The data structure may further comprise fourth computer code executable to allocate a correlation value to at least some of said third data, wherein said correlation value represents congruence of locations represented by said first data with locations represented by said second data.

The correlation value may be dependent upon the sum of products of coordinate values of locations represented by said first data with respective coordinate values of said locations represented by said second data.

The correlation value may be dependent upon the sum of products of deviations of coordinate values of locations represented by said first data with respective coordinate values of said locations represented by said second data.

The data structure may further comprise fifth computer code executable to reject third data having a correlation value below a selected second value.

The data structure may further comprise sixth computer code executable to obtain said first and second data from first and second image data of said object.

According to a further aspect of the present invention, there is provided a computer readable medium carrying a data structure as defined above stored thereon.

A preferred embodiment of the invention will now be described, by way of example only and not in any limitative sense, with reference to the accompanying drawings in which:

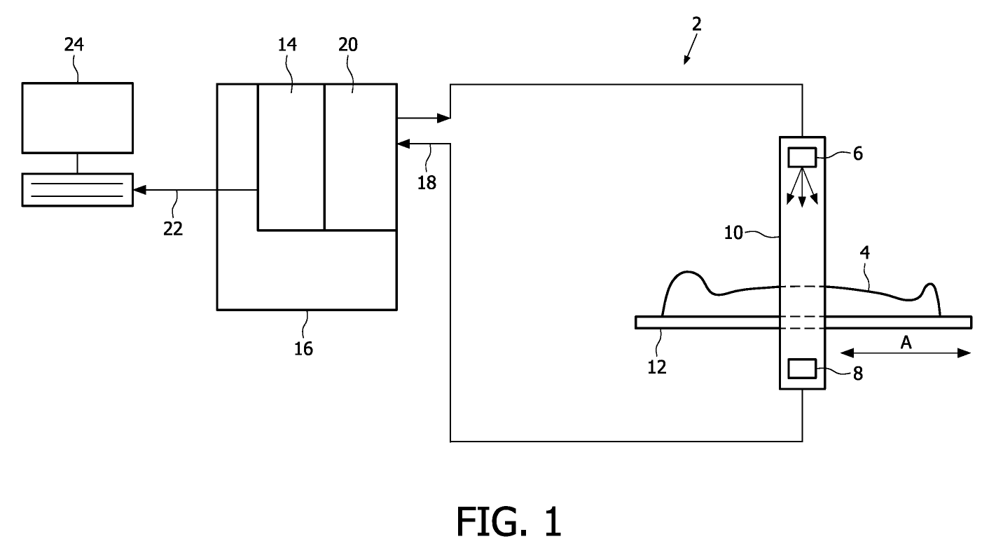

FIG. 1 is a schematic view of a colon imaging apparatus embodying the present invention;

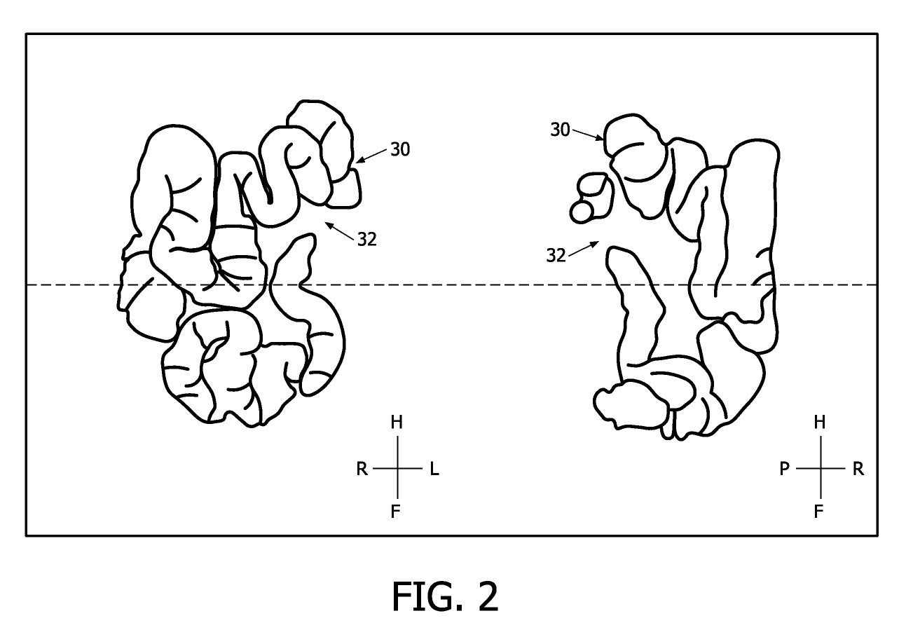

FIG. 2 is a prone colon scan displayed in two different orientations;

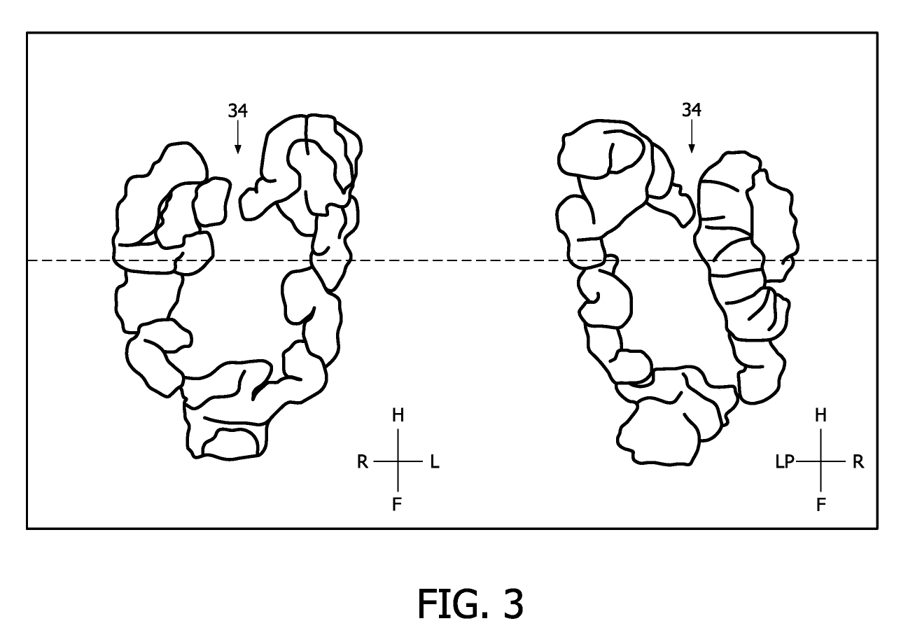

FIG. 3 is a supine colon scan, corresponding to the prone scan of FIG. 2, displayed in two different orientations;

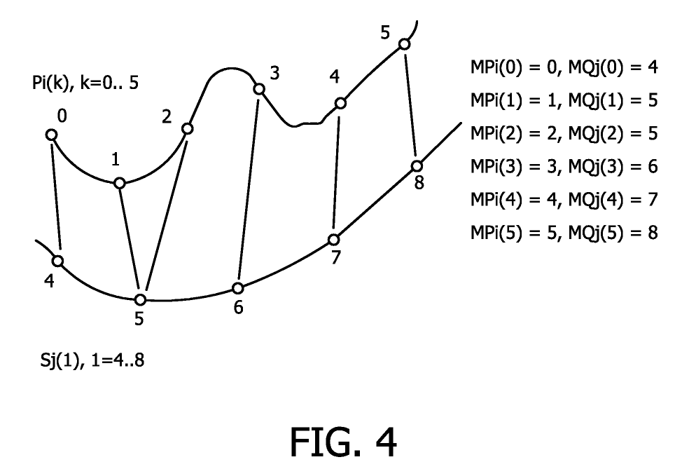

FIG. 4 is an illustration of a mapping process used to match prone and supine centerline scan data;

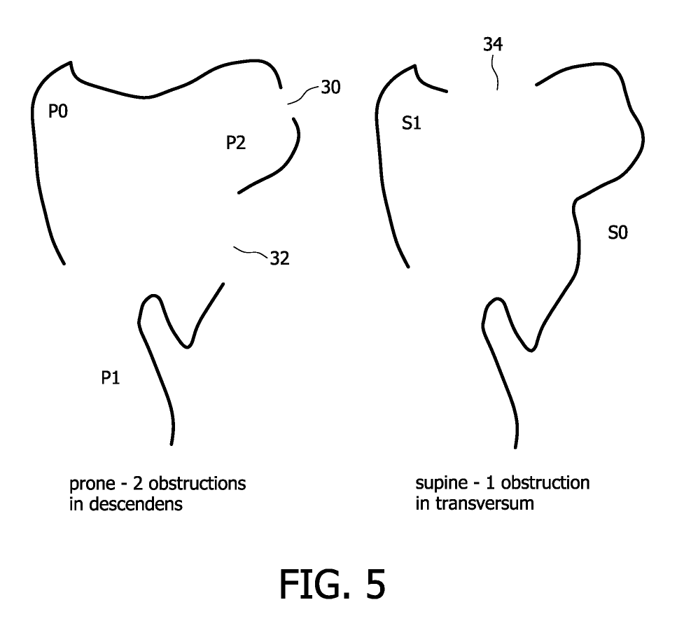

FIG. 5 illustrates tracked centerline scan data obtained by means of the apparatus of FIG. 1 from prone and supine scan imaging data of a colon having obstructions;

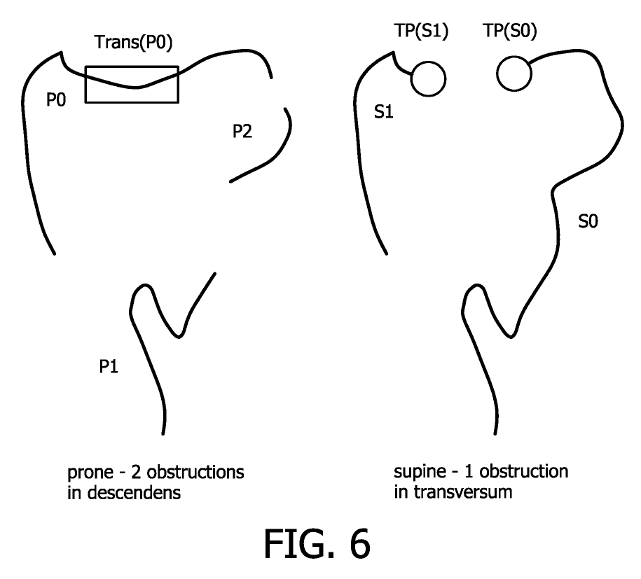

FIG. 6 represents the centerline scan data of FIG. 5, in which that part of the prone centerline scan data corresponding to gaps in the supine centerline scan data is identified; and

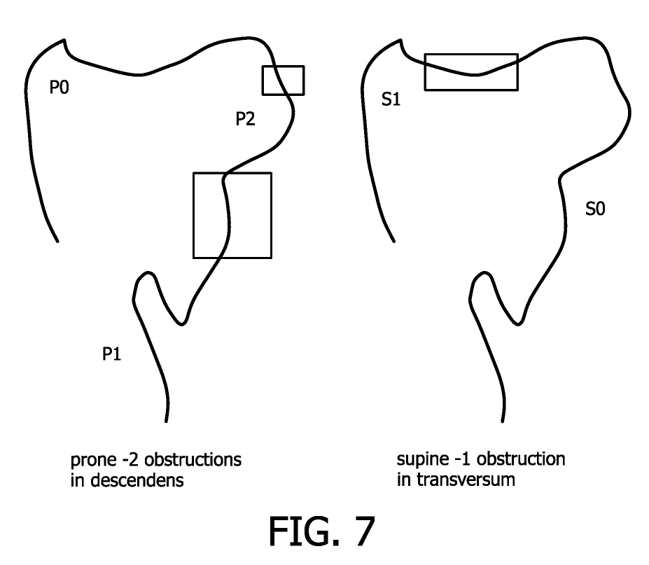

FIG. 7 represents the centerline scan data of FIGS. 5 and 6 in which centerline data of one scan corresponding to caps in the centerline scan data of the other scan has been transplanted to the other scan data.

Referring to FIG. 1, a computer tomography (CT) scanner apparatus 2 for forming a 3D imaging model of a colon of a patient 4 has an array of X-ray sources 6 and detectors 8 arranged in source/detector pairs in a generally circular arrangement around a support 10. The apparatus is represented as a side view in FIG. 1, as a result of which only one source/detector pair 6, 8 can be seen.

The patient 4 is supported on a platform 12 which can be moved by suitable means (not shown) in the direction of arrow A in FIG. 1 under the control of a control unit 14 forming part of a computer 16. The control unit 14 also controls operation of the X-ray sources 6 and detectors 8 for obtaining image data of a thin section of the patient's body surrounded by support 10, and movement of the patient 4 relative to the support 10 is synchronized by the control unit 14 to build up a series of images of the patient's colon. This process is carried out with the patient in the prone and supine positions, as will be familiar to persons skilled in the art.

The image data obtained from the detectors 8 is input via input line 18 to a processor 20 in the computer 16, and the processor 20 builds up two 3D models of the patient's colon from the image data slices, one model being based on image data obtained by the scan with the patient in the prone position, and the other model being based on image data obtained by the scan with the patient in the supine position. The processor 20 also outputs 3D image data along output line 22 to a suitable monitor 24 to display a 3D image of the colon based on the scans in the prone and supine positions.

The prone and supine scans of the patient's colon obtained by the apparatus 2 of FIG. 1 are shown in FIGS. 2 and 3 respectively, the scans in each case being shown in two different orientations. The image obtained by the prone scan is shown in FIG. 2 and shows two obstructions 30, 32, both appearing in the descending colon, as a result of which tracking of the complete colon centerline is not possible.

Similarly, the image obtained by the supine scan is shown in two different orientations in FIG. 3 and shows a single obstruction 34 in the transverse colon. It will generally be the case that obstructions will not occur in the same location in prone and supine scan images, since the residual fluid causing the obstructions will change position as the patient changes from the prone to the supine position. For example, the image of FIG. 2 shows only obstructions 30, 32 in the descending colon, whereas the image of FIG. 3 shows a single obstruction in the transverse colon only.

The processor 20 of the apparatus 2 of FIG. 1 processes the 3D models formed from the prone and supine scan data to provide prone and supine tracked centerline data as shown in FIG. 5. This is achieved for example by means of wavefront propagation techniques, which will be familiar to persons skilled in the art. The prone centerline scan data shown in FIG. 5 shows segments P0 and P1 separated by obstruction 30, and a further segment P2 separated from segment P1 by obstruction 32. Similarly, the supine centerline scan data shown in FIG. 5 shows segments S1 and S0 separated by obstruction 34.

Referring now to FIG. 4, in order to match the prone and supine centerline scan data to each other, a minimal cost mapping process is used. In order to match points lying on a curve Pi(k) with points lying on a curve Sj(1), a centerline mapping is carried out between pairs of points on the two curves. This mapping can be written as follows:

Centerline Pᵢ is parameterized in k, so defines the curve Pᵢ(k)

Centerline Sⱼ is parameterized in 1, so defines the curve Sⱼ(l)

The mapping provides a common linear parameter m for both centerlines Pᵢ and Sⱼ so that k-MPᵢ(m) and l=MSⱼ(m), where m=0 . . . M.

As a result, point Pᵢ(MPᵢ(m)) corresponds to Sⱼ(MSⱼ(m)). This technique will be familiar to persons skilled in the art.

Using dynamic programming techniques which will be familiar to persons skilled in the art, the minimal cost mapping process described above is carried out by the processor 20 for short sections of the prone and supine centerline data shown in FIG. 5. In particular, the prone centerline data will generally be available as a group of sections of centerline data, separated by interruptions for which no corresponding prone centerline data is available. For each section of prone centerline data, the above mapping process is carried out for each allowed combination of prone data points with supine data points, and combinations of data points corresponding to the ends of the section of prone centerline data having individual cost values above a threshold value are ignored.

The cost values corresponding to the remaining pairs of prone and supine data points are then summed for each allowed combination of prone and supine data points, and the matched data corresponding to the lowest sum of cost values is selected. This automatically yields data defining common points on the prone and supine centerline data present. By selecting the lowest calculated cost value, this provides the best match between the prone and supine curves Pi(k) and Sj(l), and provides an indication of where parts of curves Pi(k) and Sj(l) match each other.

The processor 20 also defines a quality measure Q for the matched data, in which Q is the sum of correlations of x, y and z coordinates of the aligned centerlines, defined by the formula:

$${Q}_{x} = \frac{\sum [ ( {x}_{1} ( m ) - {\overline{x}}_{1} ) \cdot ( {x}_{2} ( m ) - {\overline{x}}_{2} ) ]}{\sqrt{\sum {( {x}_{1} ( m ) - {\overline{x}}_{1} )}^{2} \cdot \sum {( {x}_{2} ( m ) - {\overline{x}}_{2} )}^{2}}}$$

where
x₁(m) is the x-coordinate of Pi(MPi(m));
x₂(m) is the x-coordinate of Sj(MSj(m)); and

$$Q = \frac{1}{3} ( {Q}_{x} + {Q}_{y} + {Q}_{z} )$$

The quality measure Q is an indication of the extent to which the curve formed by the prone centerline scan data is the same shape as the curve formed by the supine centerline scan data. Q has values between 0 and 1, and a higher value indicates a better mapping.

In order to further enhance the data selection process, of the data selected by the minimal cost mapping, only the data with the highest value of Q (typically above 0.8) is selected.

The prone-supine matching described above is used to determine for all possible combinations of centerline segments on both scans Pᵢ and Sⱼ which ones match well, and then only those matches having a quality measure Q larger than 0.8 are selected. In the example of FIG. 5, therefore, it can be seen that P0 partially matches S1 and S0, P2 partially matches S0, and P1 partially matches S0. Conversely, S1 partially matches P0, and S0 partially matches P0, P2 and P1.

Referring now to FIG. 6, the part Trans(P0) of prone centerline scan data Pᵢ that does not have a matching segment in scan data Sⱼ is then determined. The end points of the segments S1 and S0 between which Trans(P0) will fit if transplanted to the supine scan data are then determined, by finding the points TP(S1) and TP(S0) in Sⱼ that match the end point of Trans (P0). The part Trans(P0) of prone centerline data is then inserted between points TP(S1) and TP(S0) to provide a continuous section of tracked supine centerline.

By means of the continuous centerline, image data of the colon wall in each part of prone scan Pᵢ can be identified in the corresponding part of supine scan Sⱼ. Similarly, as shown in FIG. 7, the parts of supine centerline scan Sⱼ for which there is no corresponding part in prone scan Pᵢ are transplanted to provide a continuous section of tracked prone centerline.

The continuous sections of tracked prone and supine centerline obtained using the present invention have a number of significant advantages. Firstly, the processor 20 can arrange the separate interrupted centerline segments into the correct order so that navigation from one centerline segment to the next can be carried out automatically. Also, a complete centerline can be constructed from actual colon anatomy image data derived from a particular patient, instead of basing the centerline construction on a general model. Furthermore, since prone-supine matching can be carried out in obstructions, a user of the apparatus 2 can be made aware that a polyp found in, for example, the supine scan will be located in the obstructed part of the prone scan and will therefore not be visible in that scan.

It will be appreciated by persons skilled in the art that the above embodiment has been described by way of example only, and not in any limitative sense, and that various alterations and modifications are possible without departure from the scope of the invention, as defined by the appended claims. For example, the invention can be applied to any technique in which two images of a tubular object are to be matched, for example where different scan protocols can be used for the same anatomical object, or for imaging of blood vessels. The invention can also be used to match images of the same object which are separated in time, in order to rapidly detect changes in the object.

1. An apparatus for matching first image data, representing a first image of a tubular object, with second image data, representing a second image of said object, the apparatus comprising at least one processor, for receiving first data, obtained from first image data representing a first image of a tubular object, wherein said first data represents a plurality of locations adjacent a longitudinal centerline of said first image, for receiving second data, obtained from second image data representing a second image of said object, wherein said second data represents a plurality of locations adjacent a longitudinal centerline of said second image, and for matching said first data with said second data, to provide third data representing a plurality of locations, each of which corresponds to at least some of said first data and at least some of said second data, determining fourth data, representing a plurality of said locations corresponding to at least some of said first data but not corresponding to at least some of said second data, and combining said third and fourth data to provide fifth data representing a plurality of consecutive said locations corresponding to at least some of said third data and at least some of said fourth data.

2. An apparatus according to claim 1, wherein at least one said processor is adapted to match said first data with said second data by applying a mapping process to said first and second data wherein a respective cost value is allocated to a plurality of corresponding pairs of said first and second data, and said cost value represents similarity of a line joining a said location represented by said first data to adjacent said locations represented by said first data to a line joining a said location represented by said second data to adjacent said locations represented by said second data.

3. An apparatus according to claim 2, wherein the cost value represents similarity of direction of a line passing through consecutive locations represented by said first data to direction of a line passing through consecutive locations represented by said second data.

4. An apparatus according to claim 2, wherein the cost value represents similarity of curvature of a line passing through consecutive locations represented by said first data to curvature of a line passing through consecutive locations represented by said second data.

5. An apparatus according to claim 2, wherein at least one said processor is adapted to apply said mapping process to at least part of said first data, representing a plurality of consecutive said locations, and to at least part of said second data, to allocate a respective cost value to a plurality of combinations of pairs of said first and second data, to determine a respective sum of cost values for the pairs of data of each said combination, and to select said third data on the basis of said sums of cost values.

6. An apparatus according to claim 5, wherein at least one said processor is adapted to exclude from said sum of cost values data corresponding to locations adjacent one or more ends of said plurality of consecutive locations and having cost values above a selected first value.

7. An apparatus according to claim 6, wherein at least one said processor is adapted to provide said third data by selecting data having the lowest said sum of cost values.

8. An apparatus according to claim 1, wherein at least one said processor is adapted to allocate a correlation value to at least some of said third data, wherein said correlation value represents congruence of locations represented by said first data with locations represented by said second data.

9. An apparatus according to claim 8, wherein the correlation value is dependent upon the sum of products of coordinate values of locations represented by said first data with respective coordinate values of said locations represented by said second data.

10. An apparatus according to claim 8, wherein the correlation value is dependent upon the sum of products of deviations of coordinate values of locations represented by said first data with respective coordinate values of said locations represented by said second data.

11. An apparatus according to claim 8, wherein at least one said processor is adapted to reject third data having a correlation value below a selected second value.

12. An apparatus according to claim 1, wherein at least one said processor is adapted to obtain said first and second data from first and second image data of said object.

13. An apparatus for displaying first and second images of a tubular object, the apparatus comprising an apparatus according to claim 1 and at least one display device.

14. An apparatus according to claim 11, further comprising at least one imaging apparatus for providing said first and second image data.

15. A method of matching first image data, representing a first image of a tubular object, with second image data, representing a second image of said object, the method comprising:
matching first data, obtained from first image data representing a first image of a tubular object, with second data, obtained from second image data representing a second image of said object, wherein said first data represents a plurality of locations adjacent a longitudinal centerline of said first image and said second data represents a plurality of locations adjacent a longitudinal centerline of said second image, to provide third data representing a plurality of said locations, each of which corresponds to at least some of said first data and at least some of said second data;
determining fourth data, representing a plurality of said locations corresponding to at least some of said first data but not corresponding to at least some of said second data; and
combining said third and fourth data to provide fifth data representing a plurality of consecutive said locations corresponding to at least some of said third data and at least some of said fourth data.

16. A method according to claim 15, wherein matching said first data with said second data comprises applying a mapping process to said first and second data wherein a respective cost value is allocated to a plurality of corresponding pairs of said first and second data, and said cost value represents similarity of a line joining a said location represented by said first data to adjacent said locations represented by said first data to a line joining a said location represented by said second data to adjacent said locations represented by said second data.

17. A method according to claim 16, wherein the cost value represents similarity of direction of a line passing through consecutive locations represented by said first data to direction of a line passing through consecutive locations represented by said second data.

18. A method according to claim 16, wherein the cost value represents similarity of curvature of a line passing through consecutive locations represented by said first data to curvature of a line passing through consecutive locations represented by said second data.

19. A method according to claim 16, further comprising applying said mapping process to at least part of said first data, representing a plurality of consecutive said locations, and to at least part of said second data, allocating a respective cost value to a plurality of combinations of pairs of said first and second data, determining a respective sum of cost values for the pairs of data of each said combination, and selecting said third data on the basis of said sums of cost values.

20. A method according to claim 19, further comprising excluding from said sum of cost values data corresponding to locations adjacent one or more ends of said plurality of consecutive locations and having cost values above a selected first value.

21. A method according to claim 20, wherein providing said third data comprises selecting data having the lowest said sum of cost values.

22. A method according to claim 15, further comprising the step of allocating a correlation value to at least some of said third data, wherein said correlation value represents congruence of locations represented by said first data with locations represented by said second data.

23. A method according to claim 22, wherein the correlation value is dependent upon the sum of products of coordinate values of locations represented by said first data with respective coordinate values of said locations represented by said second data.

24. A method according to claim 22, wherein the correlation value is dependent upon the sum of products of deviations of coordinate values of locations represented by said first data with respective coordinate values of said locations represented by said second data.

25. A method according to claim 22, further comprising rejecting third data having a correlation value below a selected second value.

26. A method according to claim 15, further comprising the step of obtaining said first and second data from first and second image data of said object.

27. A data structure for use by a computer system for matching first image data, representing a first image of a tubular object, with second image data, representing a second image of said object, the data structure including:
first computer code executable to match first data, obtained from first image data representing a first image of a tubular object, with second data, obtained from second image data representing a second image of said object, wherein said first data represents a plurality of locations adjacent a longitudinal centerline of said first image and said second data represents a plurality of locations adjacent a longitudinal centerline of said second image, to provide third data representing a plurality of locations, each of which corresponds to at least some of said first data and at least some of said second data;
second computer code executable to determine fourth data, representing a plurality of said locations corresponding to at least some of said first data but not corresponding to at least some of said second data; and
third computer code executable to combine said third and fourth data to provide fifth data representing a plurality of consecutive said locations corresponding to at least some of said third data and at least some of said fourth data.

28. A data structure according to claim 27, wherein the first computer code is executable to match said first data with said second data by applying a mapping process to said first and second data wherein a respective cost value is allocated to a plurality of corresponding pairs of said first and second data, and said cost value represents similarity of a line joining a said location represented by said first data to adjacent said locations represented by said first data to a line joining a said location represented by said second data to adjacent said locations represented by said second data.

29. A data structure according to claim 28, wherein the cost value represents similarity of direction of a line passing through consecutive locations represented by said first data to direction of a line passing through consecutive locations represented by said second data.

30. A data structure according to claim 28, wherein the cost value represents similarity of curvature of a line passing through consecutive locations represented by said first data to curvature of a line passing through consecutive locations represented by said second data.

31. A data structure according to claim 28, wherein the first computer code is executable to apply said mapping process to at least part of said first data, representing a plurality of consecutive said locations, and to at least part of said second data, to allocate a respective cost value to a plurality of combinations of pairs of said first and second data, to determine a respective sum of cost values for the pairs of data of each said combination, and to select said third data on the basis of said sums of cost values.

32. A data structure according to claim 31, wherein the first computer code is executable to exclude from said sum of cost values data corresponding to locations adjacent one or more ends of said plurality of consecutive locations and having cost values above a selected first value.

33. A data structure according to claim 32, wherein the first computer code is executable to provide said third data by selecting data having the lowest said sum of cost values.

34. A data structure according to claim 27, further comprising fourth computer code executable to allocate a correlation value to at least some of said third data, wherein said correlation value represents congruence of locations represented by said first data with locations represented by said second data.

35. A data structure according to claim 34, wherein the correlation value is dependent upon the sum of products of coordinate values of locations represented by said first data with respective coordinate values of said locations represented by said second data.

36. A data structure according to claim 34, wherein the correlation value is dependent upon the sum of products of deviations of coordinate values of locations represented by said first data with respective coordinate values of said locations represented by said second data.

37. A data structure according to claim 34, further comprising fifth computer code executable to reject third data having a correlation value below a selected second value.

38. A data structure according to claim 27, further comprising sixth computer code executable to obtain said first and second data from first and second image data of said object.

39. A computer readable medium carrying a data structure according to claim 27 stored thereon.
